(19) United States
(12) Patent Application Publication
(10) Pub. No.: US 2021/0212870 A1
(43) Pub. Date: Jul. 15, 2021

(54) SYSTEM FOR ATTACHING A MOBILITY DEVICE TO AN ELECTRIC SCOOTER

(71) Applicant: Jerry G. Hodsdon, Concord, NH (US)

(72) Inventor: Jerry G. Hodsdon, Concord, NH (US)

(21) Appl. No.: 16/742,895

(22) Filed: Jan. 14, 2020

(51) Int. Cl. A61G 5/04; B62K 11/02

(52) U.S. Cl. CPC A61G 5/047; B62K 2202/00; B60L 2200/34; B62K 11/02

(57) ABSTRACT

A means of providing motorized locomotion to a mobility device such as a wheelchair utilizing a first portion of the present invention configured to attach immovably but releasably to an array of mobility devices and configured to interlock with the second portion of the present invention, which is configured to attach immovably but releasably to an array of electric scooters. A movable feature permits the first portion and second portion of the present invention to be interlocked while keeping all wheels of the mobility device and the scooter in contact with the supporting surface. A stand for the electric scooter lowers when the two units are separated and lifts when they are engaged, to hold the electric scooter in an approximately vertical position when not engaged and to provide freedom of movement when engaged.

### CROSS REFERENCE TO RELATED APPLICATIONS

N/A

### BACKGROUND

### Field of the Invention

The present invention relates generally to the field of combining motorized devices with non-motorized mobility devices such as wheelchairs, so as to add motorized mobility to said non-motorized mobility devices.

### Discussion of Prior Art

It is common for people with limited mobility as a result of physical disabilities to purchase a wheelchair or similar mobility device as a means of improving their mobility. Mobility devices can come in a number of different forms, ranging from a walker that incorporates a seat (a rollator), to a transport wheelchair (having four relatively small wheels), to a standard wheelchair (two large wheels with hand grips and two small wheels), to a mobility scooter, to a motorized wheelchair. For numerous reasons, people often choose non-motorized standard wheelchair initially, however, often due to changing circumstances such as, for example, further disability due to increasing age, or a need to travel longer distances, it becomes desirable to transition to a motorized mode of transport. Even when this transition seems desirable, however, the cost of motorized wheelchair, for example, can be prohibitive. In addition, the complete reliance on a motorized mobility device can both create the undesirable impression that the person is more severely disabled than they are, and it can increase their disability because they almost completely cease using the muscle groups that are utilized with non-motorized mobility devices, leading to further muscle weakness. Alternately users may purchase a second motorized mobility device such as a mobility scooter, for example, designed for longer distance transportation but not particularly suitable for use in close quarters, and must undertake the often-challenging task of having to transfer from one seat to another in order to switch from the non-motorized mobility device to the motorized mobility device. Several solutions have been developed in an attempt to address these concerns.

Mobility scooters, for example, are three or four small-wheeled mobility transport vehicles with a conventional seat and handlebars for speed and directional control. These dedicated motorized devices are typically used for longer distance transport, and would not commonly be utilized for moving around one's home for common household tasks, and therefore would typically be used in addition to a non-motorized mobility device, requiring a user with poor mobility to take on the often-difficult task of having to climb out of one to get into the other. The floor space required for storage is more than doubled when compared to just a mobility device. The present invention incorporates several advantages over mobility scooters, in that it eliminates the need for users with poor mobility to transition from one seat to another, and it requires very little additional storage space.

Some individuals and companies have adapted a two wheeled gyroscopically controlled device, commonly referred to as a hoverboard, by providing a seat with one or more attached wheels adapted to be attached to said hoverboard such as patent application US 2018/0141609 A1 to Newhouse or those offered by Hoverseat, LLC of North Miami, Fla. These devices have many of the same disadvantages as mobility scooters listed above, and the seat is commonly closer to ground level, making it even more difficult to climb in and out of the seat for a person with poor mobility. For devices controlled by foot motion, having poor leg control is a common concern for mobility device users, providing a further limitation for many potential users. The present invention incorporates the advantages noted above, and is hand operated, making it usable for people with poor leg control.

Alternately, a hoverboard can be adapted to support a rider behind the mobility device, and linked to said mobility device, such as that offered by AidWheels System by DePapeo, S L of Madrid, Spain (patent pending). This, however, requires a second person, and therefore reduces the user's independence. The present invention does not require a second person, maintaining the user's independence.

Another alternate approach is through the use of a dedicated detachable motorized system such as that described in U.S. Pat. No. 10,076,457 B2 to Behm, U.S. Pat. No. 10,172,750 B1 to Dickie, U.S. Pat. No. 3,921,744 to Benoit, U.S. Pat. No. 4,386,672 to Coker, U.S. Pat. No. 5,050,695 to Kleinwolterink, and U.S. Pat. No. 5,494,126 to Meeker. These are all relatively complex motorized devices with a large number of specialized parts made in small volume, which significantly drives up the cost per unit. Attachment and detachment are in most cases complex, and require very specific mobility device designs and typically require extensive modifications, making it impossible or impractical for most users with existing mobility devices to add these motorized systems. In contrast, the present invention is designed to work with any of a broad range of commonly available commercially produced electric scooters, thus reducing the cost, and benefitting from the proven reliability and availability of said electric scooters. In the preferred embodiment, the present invention is easily attachable to both the scooter and the mobility device without drilling or making other modifications to existing equipment, and the significant adjustability further allows it also to be used in conjunction with any of a broad range of non-motorized mobility devices, so that, in most cases, the user can adapt it to their existing mobility device.

Of particular relevance to the present invention are other means of attaching a motorized scooter to a mobility device, such as U.S. Pat. No. 9,757,290 to Scognamiglio and U.S. Pat. No. 7,306,250 B1 to Mills. With regard to both these designs, in order for the user to engage the mobility device with the device attached to the scooter, the user must be able to balance the mobility device on two wheels in order to lift the engagement mechanism over intervening obstacles, as shown in FIG. 14 and FIG. 15 of U.S. Pat. No. 9,747,290. This is dangerous, as the user could lose balance and fall backwards risking possible brain injury, and is beyond the capabilities of many more severely disabled and elderly users. One of the primary reasons both require this unsafe action is because the engaging portion attached to the mobility device must be lifted over the rear wheel. In addition, the height and width adjustments are made using fixed hole locations, so they may not fit properly. The portion that attaches to the mobility device is very limited in adjustability, and therefore can be utilized with a very small range of mobility devices. In some cases, it may require drilling holes in the mobility device or scooter for mounting purposes. Another relevant prior art disclosure is US2004/0000440 A1 to Sawyer. One disadvantage of the Sawyer disclosure is that the front wheels need to be driven up a ramp and remain in an elevated position. Driving up a ramp may be difficult for some users, and the elevated position during use tilts the wheelchair back, sending the center of gravity closer to the rear wheels of the wheelchair, which could result in the user falling backwards. More importantly, because the Sawyer disclosure uses the front wheels of the wheelchair as an attaching means, the width of the wheelchair will greatly affect the usability of the invention. Wheelchairs can be as narrow as 16 inch seats and as wide as 30 inch seats. The range of usable wheelchair configurations is thus somewhat limited without major design configuration changes. Because the components extend a significant distance sideways, it is foreseeable that the frame could become angled and scrape on the floor during a turn, for example, which could damage wooden or other vulnerable flooring. It will be demonstrated that the present invention overcomes these concerns, and incorporates additional features and benefits not provided in prior art.

### BRIEF DESCRIPTION OF THE INVENTION

It is common for individuals who have disabilities that require them to use a wheeled mobility device to initially purchase a non-motorized mobility device, such as a rollator, a transport wheelchair, or a standard wheelchair. While this usually provides improved mobility, there are often circumstances where a motorized mobility device would be advantageous, such as a need or desire to travel longer distances, or a subsequent degradation of health making manually driven travel more difficult. The present invention provides a simple and effective means of utilizing any of a broad range of mass produced motorized scooters and coupling it with any of a broad range of mobility devices in such a way as to provide a motorized drive to said mobility device.

The present invention incorporates one assembly that is immovably and removably attached to said mobility device, and a second assembly that is immovably and removably attached to said electric scooter. One of the two assemblies incorporates a movable, preferably spring loaded component that, when the two assemblies are rolled into position, engages positively with the mating component. In the preferred embodiment, there are two engagement points, which are further apart than the width of the rear wheel assembly of said electric scooter, allowing the rear wheel assembly of said scooter to pass underneath the assembly attached to said mobility device without interference, for the purpose of engaging the two assemblies. Once engaged, relative horizontal linear and rotational movement between said mobility device and said scooter is severely restricted, effectively interlocking the two units together. The assembly would, however, allow for some relative vertical linear and rotational movement, to accommodate variations in terrain traveled. In the preferred embodiment, disengaging said assemblies requires only to push the movable component in the direction opposed to the spring pressure in order to disengage the engaging mechanism, and then move the scooter away from the mobility device until the engaging mechanism is cleared. An alternate embodiment could incorporate a catch that would need to be released first, or it could be released simultaneously.

The assembly that attaches to the mobility device would be easily adjustable in width as well as height and the distance between the locking components, and would attach to the vertical supports near the front of a variety of different mobility devices. The vertical adjustability would allow the user to avoid obstacles such as connecting horizontal support bars in the frame of said mobility device. The width is adjustable so that one assembly could be used for a broad range of mobility device widths. In the preferred embodiment, the width is self-adjusting during assembly, by allowing each pair of outer tubes to slide over an inner tube. By having a gap between said outer tubes once assembled, if one desired to remove a portion of the assembly to collapse said mobility device for transportation purposes, for example, only two of the four attaching means needs to be opened. At that point, the gap between the outer tubes allows the outer tubes to be moved towards each other to allow the assembly to clear the vertical support of the mobility device to which it was attached. The assembly can now swing forwards, and the inner tubes can be slid out of the outer tubes of the section that is still attached, while remaining inside the outer tubes of the portion that was just dis-attached. The dis-attached assembly including said inner tubes can be put aside for storage, and the attached portion can be swung into a position that does not inhibit collapse of said mobility device. Reassembly is accomplished by simply reversing the above procedure.

The assembly that attaches to said electric scooter can be placed in the preferred position, front to back, so as to position the scooter handles in a comfortable location once the mobility device and the scooter are interlocked. The preferred means of attachment of said assemblies to said mobility device and electric scooter would not require the use of tools, but would preferably be attached by means such as hook and loop straps, cinch straps, or some form of hand operated clamping device. On occasion, mobility devices are collapsed for storage during automotive transport, for example, so simple removal and attachment is preferred. In addition, it would be advantageous for some users, for example, the elderly with grandchildren, to be able to easily remove the attached assembly from said electric scooter and permitting it to be used per its original design intent.

In order to interlock said mobility device and said electric scooter, said scooter is positioned directly in front of said mobility device, with their respective centerlines coincident with each other. The two are then moved towards each other. Because the component that attaches to said mobility device has attaching points that are further apart than the width of the rear wheel assembly of said scooter, said wheel assembly does not interfere with the movement towards each other. In the preferred embodiment, as the two portions of the present invention come into contact, further movement along the common centerline acts to pivot the movable section of the second portion of the present assembly, compressing the spring, until the two sections latch together.

The interlocking mechanism would, as noted, preferably constrain movement in all horizontal directions, but should allow some degree of vertical linear or rotational motion. In the preferred embodiment, the movable spring loaded component would be on the scooter and would be spring loaded upward against a fixed assembly on the mobility device, so that irregularities in the surface over which the system is traveling can be negotiated without risking the unintentional decoupling of the two assemblies. One means of interlocking would be through a loosely fitting post and hole method, which is the method described in detail herein. Alternately, numerous latching systems could be used. In an alternate embodiment, the assembly on the mobility device could be spring loaded downward against a fixed assembly on the scooter, thus achieving a similar benefit.

This interlocking of said assemblies would occur with all four wheels of the mobility device and both wheels of said electric scooter on the ground, making it novel and advantageous over other scooter-mobility device adapters. Because the system is simple and easy to engage and disengage, a user could use their manually driven mobility device around their home or in a dining area, for example, but when they need to leave, they dock to the electric scooter and travel where they need to go. Once they arrive, they can easily un-dock and go back to using just the mobility device, if they so desire, all the time remaining seated.

This ease of use is further enhanced by an additional novel feature that would enable to scooter to remain in a vertical position without additional support when disengaged. In the preferred embodiment, the spring loaded movable component would pivot on an axle, such that it is spring loaded upward with a travel limiting device to fix the angle of the component when not engaged. An additional novel feature that would benefit the preferred embodiment is the mounting of an adjustable leg on one, or preferably both, end(s) of an axle of the spring loaded movable component of the assembly, roughly perpendicular to said axle, and positioned such that the far end of the leg(s) is roughly at, or just above ground level when the two assemblies are disengaged. When the assemblies are engaged, the movable portion pivots, rotating the axle, causing the legs to rotate such that there is a reasonable distance between the leg end(s) and ground level. The benefit of this feature is that when the scooter is separated from the mobility device, the legs act like a kickstand or center stand, holding the scooter in an approximately upright position, and when the scooter and mobility device are linked together, the leg or legs lift away from the ground permitting freedom of movement. All this is accomplished without additional effort by the user to engage the stand.

### OBJECTS AND ADVANTAGES

A primary object of the present invention is to provide powered locomotion to an array of manually driven mobility devices such as rollators, transport wheelchairs, and standard wheelchairs.

Another object of the present invention is to provide a low cost and reliable system for interlocking an array of mobility devices to an array of readily available, mass produced, low cost means of motorized locomotion.

Another object of the present invention is to restrict relative horizontal linear and rotational movement between said mobility device and said electric scooter by means of an interlocking mechanism, while allowing some degree of relative vertical linear and rotational movement, to better accommodate variations in travel terrain.

Another object of the present invention is to be able to accomplish the interlocking procedure with all four wheels of said mobility device and with both wheels of said electric scooter in contact with the supporting surface during the entire interlocking procedure.

Another object of the present invention is to be able to easily separate the motorized portion from said mobility device for lifting purposes, as they are much more easily lifted individually to place them into a trunk, for example, than if they were a single inseparable unit.

Another object of the present invention is to cause the electric scooter to remain in an approximately upright position when disengaged, ready for use, and to have the procedure of engagement lift the support or supports that hold said electric scooter in an approximately upright position, so that the engaged assembly can travel without encumberment once engaged.

Another object of the present invention is to allow rapid transition to and from a motorized system to a more standard non-motorized mobility device, so that dining or activities around the home are not incombered or interfered with by the motorized portion, as well as to allow rapid transition from a non-motorized mobility device to a motorized system, for convenience whenever motorized travel is preferred, however since the user still uses manual methods of movement, the strength of those muscle groups will be maintained through continued intermittent use of important muscle groups.

Another object of the present invention is to be able to partially disassemble the portion of the present invention that is attached to said mobility device with minimal time and effort so that it does not inhibit the collapsing of said mobility device for transportation purposes, for example.

### BRIEF DESCRIPTION OF THE DRAWINGS

FIG. 1 shows a mobility device, an embodiment of the portion of the present invention that attaches to said mobility device, an electric scooter, and an embodiment of the portion of the present invention that attaches to said electric scooter, shown in the interlocked position.

FIG. 2 shows a mobility device, and an embodiment of the first portion of the present invention that attaches to said mobility device.

FIG. 3 shows an embodiment of the first portion of the present invention that attaches to said mobility device.

FIG. 4 shows an electric scooter, and an embodiment of the second portion of the present invention that attaches to said electric scooter.

FIG. 5 shows an embodiment of the portion of the present invention that attaches to said electric scooter.

FIG. 6 shows a top view of an embodiment of the second portion of the present invention that attaches to said electric scooter.

FIG. 7 shows a side view of an embodiment of the second portion of the present invention that attaches to said electric scooter in the non-engaged state.

FIG. 8 shows a side view of an embodiment of the second portion of the present invention that attaches to said scooter in the approximate position said embodiment would be when engaged.

FIG. 9 shows a side view of both portions of the present invention, a section of said electric scooter, and the vertical post representing the vertical front leg of a mobility device, shown prior to engagement.

FIG. 10 shows a side view of both portions of the present invention, a section of said electric scooter, and the vertical post representing the vertical front leg of a mobility device, shown after engagement.

### DETAILED DESCRIPTION OF THE PRESENT INVENTION

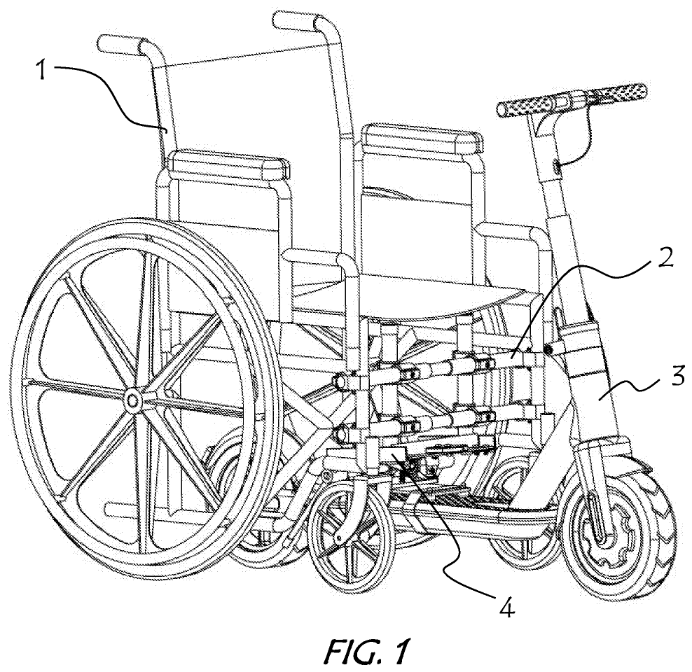

The present invention is a simple and effective means of adapting a hand operated mobility device such as a wheelchair to an electric scooter so as to provide a means of motorized movement. Shown in FIG. 1, is a means of interlocking a mobility device such as a wheelchair 1 to an electric scooter 3 by attaching the first portion of said invention 2 to said mobility device 1 and a second portion of the present invention 4 to said electric scooter 3. The first portion 2 and the second portion 4 interlock with each other in such a way as to greatly restrict relative horizontal linear and rotational movement between said mobility device 1 and said scooter 3, effectively interlocking them, while permitting some relative vertical and rotational movement to accommodate varying terrain over which it is traveling.

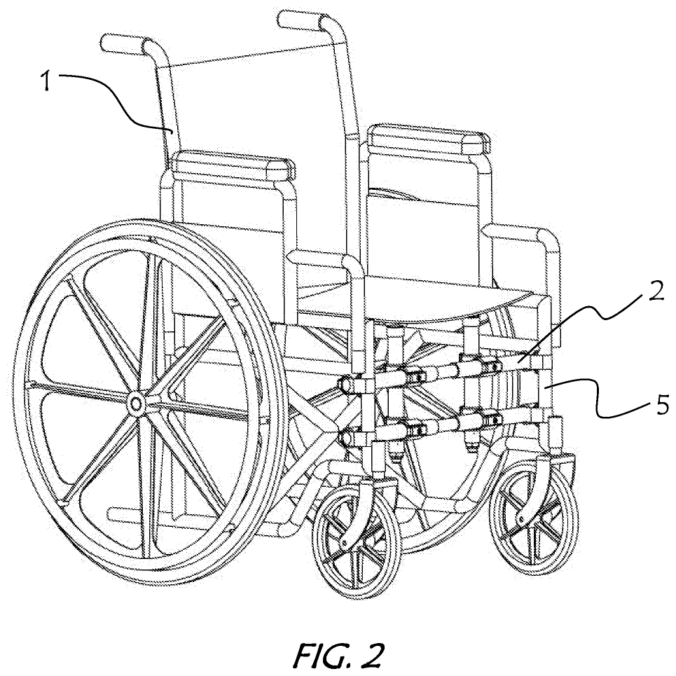

As shown in FIG. 2, the first portion of said invention 2 attaches to said mobility device 1 by fastening means to the front vertical supports 5 of said mobility device 1.

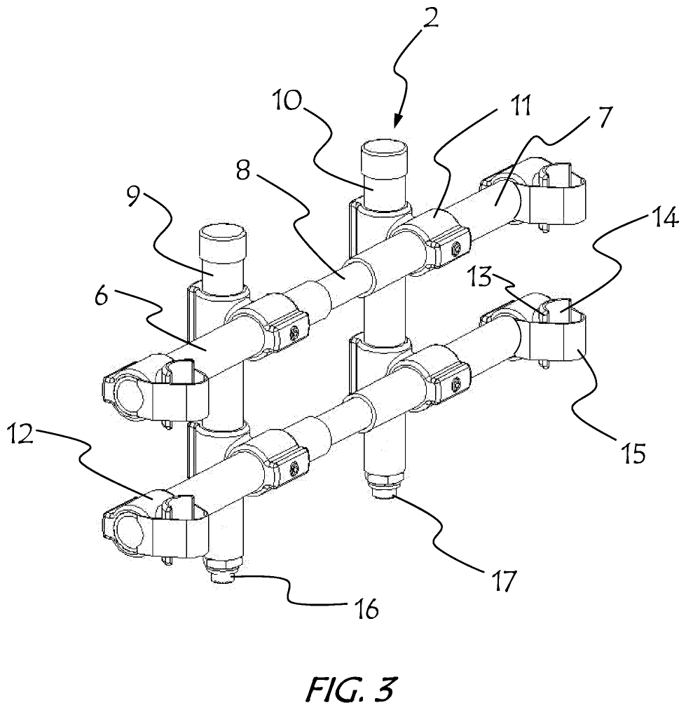

A detailed view of a preferred embodiment of said first portion 2 of the present invention is shown in FIG. 3. The primary function of the first portion is to positively engage with said mobility device 1, and can do so over a range of different width and differently configured wheelchairs or other mobility devices. A secondary function is, once engaged to said mobility device 1, to be able to position vertical columns 9 and 10 so that they are at the appropriate height and separation to correctly engage with said second portion 4 of the present invention, as shown in FIG. 1.

The preferred embodiment would incorporate outer tubes 6 and 7 that slide movably over an inner tube 8, so that the total length can be varied to accommodate various width mobility devices without the need for additional adjustment. Said vertical coumns 9 and 10 would be immovably but repositionable attached to a portion of the approximately horizontal assemblies, for example said outer tubes 6 and 7, using cross bar clamp-on framing fittings 11 or other similar means. Attached to one end of said outer tubes 6 and 7 are fittings 12 that can be affixed immovably to said outer tubes. In the preferred embodiment, said fittings would have at least one curved concave surface 13 to receive said front vertical support 5 as shown in FIG. 2, of said mobility device. Said curved concave surface 13 would preferably have adhered to it a compliant component 14 made of foam rubber or a similar material, both to provide suitable accommodation for a range of vertical support diameters as might exist over a range of mobility devices, as well as to provide a surface with a high coefficient of friction to resist vertical slippage of said fitting 12 once attached. Further, said fitting 12 would have a sufficiently large diameter through hole so as to not only accommodate said outer tubes 6 and 7, but also to allow a strap 15 to pass through said fitting between the outer wall of said outer tubes 6 and 7 and the inner wall of said fitting 12, Said strap 15 would be used to attach the first portion of the present invention 2 to said mobility device 1, as shown in FIG. 2, in a way that is immovable but that can be opened easily for removal if desired, such as when said mobility device 1 might need to be collapsed for transportation, for example. Said strap 15 could be made of a hook and loop material, for example, and would preferably incorporate a means of multiplying the tightening force, such as a buckle or other means, or it could be a simple cinch strap with two rings, for example, or it could be another form of releasably self-engaging strap. Alternately, it could be a releasably clamping mechanism. Alternately, it could be a more permanent means of connecting to the mobility device, however that would be less preferred.

In the preferred embodiment, there would be at least two connection points in the first portion 2 that engage with two connection points the second portion 4 of the present invention. In an alternate embodiment, the connection between the first and second portion of the present invention could be a single point, wherein relative linear motion would be constrained, however relative horizontal rotational movement would not be constrained. This embodiment is less preferable, however, as it could allow the rear wheel of said scooter 3 to contact the framework or wheels of said mobility device 1. By having two connection points, another advantage is that the connection points 16 and 17 can be positioned such that they are on either side of the rear wheel assembly of said electric scooter 3. Further, the preferred embodiment would incorporate a means of allowing vertical and horizontal adjustability between the vertical columns 9 and 10 and the horizontal outer tubes 6 and 7 can be positioned in an area of the vertical support of the mobility device 5 that is free from interfering components, and the vertical columns 9 and 10 such that the protruding cylindrical or otherwise interlockable shapes 16 and 17 can be positioned at the correct height and separation from one another, while maintaining approximate centrality when fully assembled, so as to properly engage with the second portion 4 of the present invention.

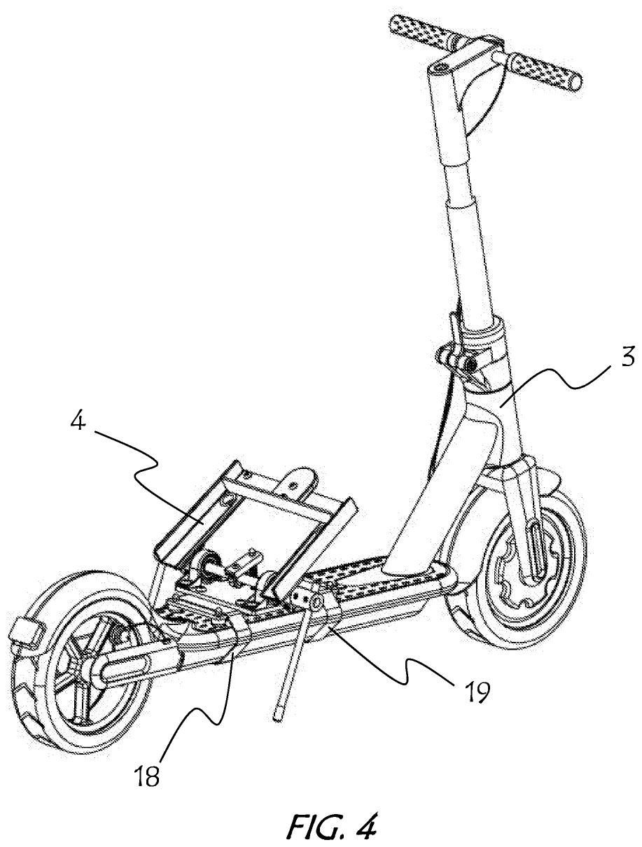

FIG. 4 shows said electric scooter 3 with the second portion of the present invention 4 mounted on said electric scooter 3. In the preferred embodiment, said second portion of the present invention 4 is attached to said electric scooter 3 utilizing straps 18 and 19 that can be tightened to make an immovable connection between the two. Said straps 18 and 19 would be used to attach the second portion of the present invention 4 to said scooter 3 in a way that is immovable but that can be opened easily for removal if desired, such as when said electric scooter 3 might need to be utilized in as per the original design intent, for example. Said straps 18 and 19 could be made of a hook and loop material, for example, and would preferably incorporate a means of multiplying the tightening force, such as a buckle or other means, or it could be a simple strap with two rings, for example, or it could be another form of releasably self-engaging strap. Alternately, it could be a releasably clamping mechanism. Alternately, it could be a more permanent means of connecting to the mobility device, however that would be less preferred. Utilization of straps or clamping devices would eliminate the need for screws or drilling holes or other more cumbersome mounting methods.

FIG. 5 shows a preferred embodiment of said second portion of the present invention 4. In the preferred embodiment, the components would rest upon a primary support plate 20, which preferably would have attached to it several feet 21 that would be made of a high coefficient friction material such as rubber, for example, to aid in achieving an immovable attachment, and would better accommodate an irregular or curved surface to which it could be attached. In one embodiment, said primary support plate 20 would have attached to it a secondary support plate 22 that is wider than said support plate to better accommodate the mounted bearings 23 so as to be more resistant to torque loads as a result of horizontal rotational movement of said scooter 3. In an alternate embodiment said primary support plate 20 and secondary support plate 22 would be integrated into a single plate. The mounted bearings 23 support a pivoting shaft 24 which allows a number of components to pivot relative to several other components. The advantage of the pivoting action is that it allows said mobility device 1 to move directly over said scooter and engage the first portion 2 and the second portion 4 of the present invention without the need for unsafe elevation of the front wheels of said mobility device 1 to engage said scooter 3 to said mobility device 1.

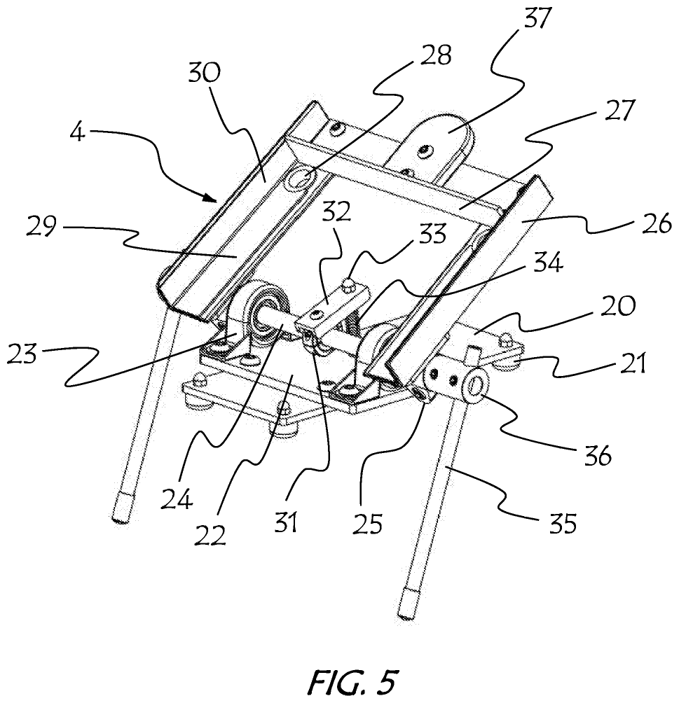

In a preferred embodiment, clamp-on framing fittings 25 are clamped to said pivoting shaft 24 and attached to a pair of pivot arms 26, each with two planar surfaces that are at an approximately ninety-degree angle relative to one another. At the other end of said pivot arms 26 is attached a connecting stop bar 27. It is preferable that said pivot arms 26 are slightly angled relative to one another, as shown in FIG. 6, so that they are further apart at the ends closest to said pivoting shaft 24, and closer together at the ends closest to said connecting stop bar 27. The relative angle one to another provides a lead in so that alignment between said mobility device 1 and said scooter 3 is less critical initially, while providing the needed constraint to provide the required alignment for engagement of the first portion 2 to said second portion 4 of the present invention towards the final stage of engagement. One means of engagement is using a post and hole type connection, wherein, for example, a post such as 16 and 17 in FIG. 3, which would engage in a hole that may or may not have a liner such as a bushing 28. Since, during engagement, said posts 16 and 17 slide along the pivoting arms 26 prior to engagement, it is preferable that a wear resistant low coefficient of friction material strips 29 be adhered to the bottom of said pivoting arms 26, as well as similar strips 30 being adhered to the sides of said pivot arms. The assembly would preferably be spring loaded upwards. One means by which this could be accomplished is by means of a shaft collar 31 adapted to be fastened to an arm 32 that fits over a shoulder screw 38 for example, as shown in FIG. 8. Said arm 32 would be captured by a locking nut 33 to limit the range of motion of the movable portion of the assembly. The spring 34 would be positioned under said spring arm 32 and around said shoulder screw 38, so that said shoulder screw 38 would keep said spring 34 contained within a restricted area of movement. A protruding member such as foot pedal 37 could be incorporated to facilitate disengagement by applying downward pressure using the feet or hands to push the pedal downwards.

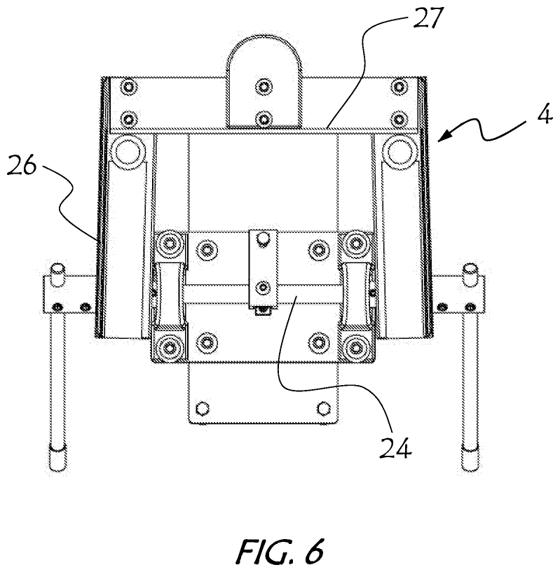

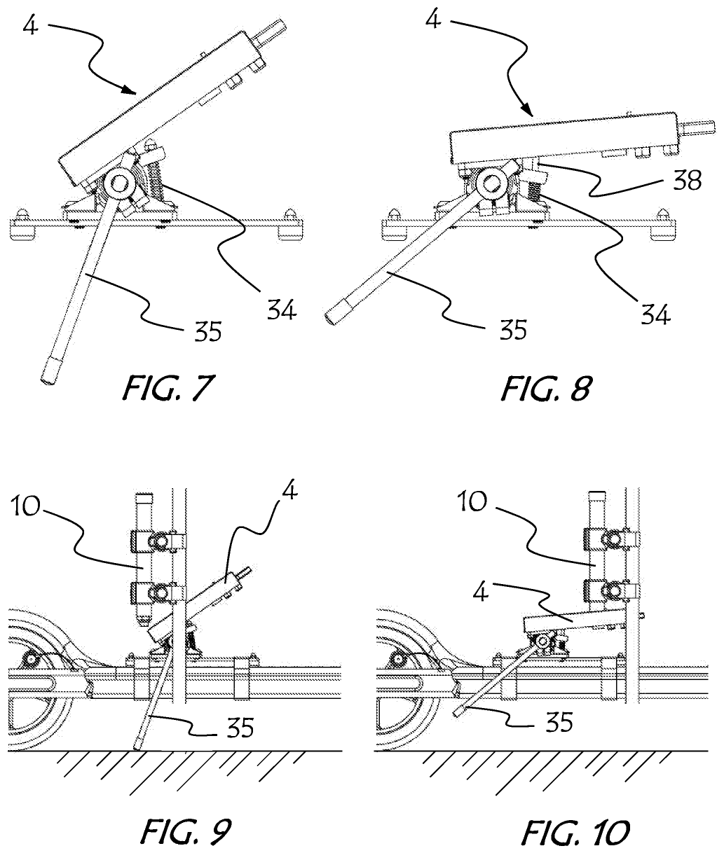

In one embodiment of the present invention, attached to the pivoting shaft 24 would have on one or both ends a collar 36 that attaches to said pivoting shaft 24 and one or more support legs 35. As shown in FIG. 7 and FIG. 9, said support legs would be in a lower position to hold said electric scooter 3 in a somewhat vertical position when the second portion 4 is in the elevated position supported by spring 34. When the movable section of the second portion of the present invention 4 is in the position that it is in when engaged with the vertical support legs 10, as shown in FIG. 8 and FIG. 10, the spring 34 is compressed state and the support rods are in a somewhat elevated position so that the interlocked mobility device 1 and electric scooter 3 can move freely without hindrance.

Because some mobility devices may have angled generally vertical front support members on their frame, it is also within the purview of the present invention to provide additional members that adjustably spans the distance between the upper crossbar and the angled generally vertical frame member of said mobility device in order to be able to hold said first portion in an approximately vertical orientation required to make it adaptable for a broader array of mobility devices. Alternately, the first portion of the present invention could be configured to adapt to generally horizontal members of said mobility device frames.

1. A means of interlocking a mobility device such as a wheelchair, for example, with an electric scooter, utilizing
a first portion of the present invention that is configured to attach to said mobility device, and a second portion that is configured to attach to said electric scooter,
at least one of the two portions having a moveable component or components configured in such a way as to allow said mobility device to pass partially over said electric scooter to interlock said first and second portion of the present invention while keeping all wheels of said mobility device and both wheels of said scooter in contact with the supporting surface on which it is rolling,
wherein at least a portion of said movable component(s) being spring loaded so as to be self-engaging,
and wherein the first portion that attaches to the mobility device is configured so as to not interfere with the rear wheel of said electric scooter during the interlocking process.

2. The invention of claim 1 wherein there is at least one interlocking point that restricts relative horizontal linear movement between said mobility device and said electric scooter,
and preferably a second interlocking point that restricts relative horizontal rotational movement between said mobility device and said electric scooter.

3. The invention of claim 1 wherein said second portion of the present invention is configured to interlock removably to the first portion of the present invention, wherein said movable component of said second portion pivots around an axis of rotation.

4. The invention of claim 1 wherein the movable component of the second portion is spring loaded in an upward direction so that the first portion will slide into and stay in an interlocked position without additional direct manual intervention.

5. The invention of claim 1 wherein the movable component of said second portion of the present invention has at least one, but preferably two pivot arms connected to a rod at the axis of rotation, and connected to a crossbar, preferably at or near the other end of said pivot arms. In the preferred embodiment, the connecting point between the second and first portion of the present invention would be at or near the end of said pivot arms, such as a hole that would receive a post, for example. In the preferred embodiment, the crossbar has a barrier wall that stops any engaging component from moving past said interlocking point or points.

6. The invention of claim 1 wherein, in an alternate embodiment, the crossbar is a rod or other shape configured to be the interlocking point or points, wherein the interlocking point in the first portion of the present invention could be an approximate ‘C’ shape, for example, to receive said crossbar, wherein the shape is configured to resist unintentional disengagement.

7. The invention of claim 1 wherein, in an alternate embodiment, said connecting points on said movable component have some vertical and or angular freedom of movement, to allow said connecting points to move with some independence, to better accommodate variation in the vertical angular position of said electric scooter relative to said mobility device.

8. The invention of claim 1 wherein a movable and automatically lowering and raising stand is composed of at least one, but preferably two legs or similarly functioning members attached adjustably to the axis of rotation of said movable component of said second portion of the present invention, so that said leg or legs are lowered and functional when said mobility device and said electric scooter are not engaged, holding said electric scooter in and approximately vertical position, but raised to provide clearance for travel when said mobility device and said electric scooter are engaged and interlocked.

9. The invention of claim 1, wherein the first portion of the present invention has at least two horizontally adjustable components or assemblies that attach to the framework of said mobility device, and at least one, but preferably two vertically adjustable components, at the end or ends of which exist an interlocking mechanism to engage and interlock with said second portion, thereby providing adjustability required to adapt to an array of mobility devices and electric scooters.

10. The invention of claim 1 wherein the both the first portion and the second portion of the present invention are immovably but removably attached to said mobility device and said electric scooter through the use of reusable straps such as straps that incorporate hook and loop, and preferably a buckle through which it passes at one end to multiply the tightening force, or a cinch strap with a buckle or two rings at one end, or a clamping device.

11. A method of using a movable component to enable a mobility device such as a wheelchair to be interlocked with an electric scooter
while maintaining full contact between all wheels of both the electric scooter and said mobility device with the supporting surface
for the purpose of providing motorized locomotion to said mobility device,
wherein a stand is integrally connected to the movable component to provide stability and uprightness to said electric scooter when disengaged and freedom of movement when engaged,
and wherein the component that attaches to the mobility device is configured so that it would not interfere with the rear wheel of said electric scooter during the interlocking process.

12. The invention of claim 11 wherein the movable component pivots around an axis.

13. The invention of claim 11 wherein there are at least two interlocking points restricting relative horizontal linear and rotational movement between said mobility device and said electric scooter, while allowing for some relative vertical linear and rotational movement.

14. The invention of claim 11 wherein the first portion and the second portion of said invention are immovably and releasably attached to said mobility device and said electric scooter by means of straps with force multiplying cinch mechanisms.

15. The invention of claim 11 wherein the first portion of the present invention is configured to be self-adjusting in width to adapt readily to an array of mobility devices, and adjustable in interlocking point height to adapt readily to an array of mobility device and electric scooter geometries.

16. The invention of claim 11 wherein, in an alternate embodiment, the interlocking points incorporate a latch or latches that maintains the proximity of the interlocking points, and is released by the same action that it taken to separate the first and second portion of the present invention.

17. A method of using a spring loaded movable component or components to enable a mobility device such as a wheelchair to be interlocked with an electric scooter
while maintaining full contact with all wheels of said mobility device and the supporting surface,
interlocking a first portion attached to said mobility device and a second portion attached to said electric scooter without direct manual intervention,
for the purpose of providing motorized locomotion to said mobility device,
while also providing stability to said electric scooter when disengaged using a stand that moves down when the movable component is disengaged up when the movable component is engaged,
and being configured to circumvent the rear wheel of said electric scooter during engagement and disengagement of said portions.

18. The invention of claim 17 wherein the movable component is integrated into the first portion of the present invention attached to said mobility device, configured to interlock with a fixed interlocking point on the second portion of the present invention attached to said electric scooter.

19. The invention of claim 17 wherein there is at least one interlocking point to restrict relative horizontal linear motion between said mobility device and said electric scooter, or preferably two interlocking points to restrict relative horizontal linear and rotational movement between said mobility device and said electric scooter, while permitting some relative vertical linear and rotational movement to accommodate variations in terrain being traversed.

20. The invention of claim 17 wherein the movable component on the second portion of the present invention pivots on an axis,
has two arms on which said first portion interlocking features slide and move the movable assembly downward during assembly, compressing a spring,
has a stop bar at the opposite end of the arms as the axis on which it pivots,
has two connecting points that are partially aligned with the connecting point on the first portion in the sideways direction by the sidewalls of said arms, and in the forward direction by the stop bar to aid in assembly
and by pressure from the spring, interlocks with the first portion of the present invention.
